(19) United States
(12) Patent Application Publication
(10) Pub. No.: US 2025/0154306 A1
(43) Pub. Date: May 15, 2025

(54) Aqueous Dispersion Comprising a Multistage Polymer and Process of Making the Same

(71) Applicants: DOW GLOBAL TECHNOLOGIES LLC, Midland, MI (US); ROHM AND HAAS COMPANY, Collegeville, PA (US)

(72) Inventors: Baoqing Zheng, Shanghai (CN); Fu Zhan, Shanghai (CN); Yawei Xu, Shanghai (CN); Yaobang Li, Shanghai (CN); Yujiang Wang, Shanghai (CN); Alvin M. Maurice, Lansdale, PA (US)

(21) Appl. No.: 19/022,473

(22) Filed: Jan. 15, 2025

Related U.S. Application Data
(62) Division of application No. 17/610,805, filed on Nov. 12, 2021.

(51) Int. Cl. C08F 220/18; C08L 33/06; C09D 133/06

(52) U.S. Cl. CPC C08F 220/1804; C08L 33/06; C09D 133/06; C08F 2438/02; C08L 2201/54; C08L 2205/03

(57) ABSTRACT

A coating composition comprising an aqueous dispersion of a multistage polymer. The multistage polymer comprises a first polymer, a second polymer, and a third polymer. The first polymer has a Tg less than 0° C. and comprises structural units of a carbonyl-containing functional monomer. The second polymer has a Tg less than 0° C. and comprises from 0.1% to 10% by weight of the second polymer of a multifunctional monomer containing two or more different ethylenically unsaturated polymerizable groups. The third polymer having a Tg higher than 50° C. comprises structural units of an ethylenically unsaturated nonionic monomer. A coating formed from the coating composition has a 600 gloss retention >50% after the QUV testing for 1,100 hours or longer and/or impact resistance of at least 40 cm-kg.

### CROSS-REFERENCE TO RELATED APPLICATIONS

This divisional application of application Ser. No. 17/610,805 filed Nov. 12, 2021, which is a National Stage application of PCT/CN2019/090666, filed Jun. 11, 2019, which is incorporated by reference herein in its entirety.

### FIELD OF THE INVENTION

The present invention relates to an aqueous dispersion comprising a multistage polymer and a process of making the same.

### INTRODUCTION

Aqueous or waterborne coating compositions are becoming increasingly more important than solvent-based coating compositions for less environmental problems. The coating industry is always interested in developing coating compositions without or with substantially reduced or low volatile organic compounds (VOCs). Waterborne coating compositions are typically formulated using aqueous dispersions of polymer latex as binders. After application of coating compositions to a substrate, the aqueous carrier evaporates, and the individual latex particles coalesce to form an integral coating film. Coalescents and/or solvents may be utilized to facilitate film formation, which may contribute VOCs. To eliminate or minimize the use of coalescents and/or solvents, it is desirable to provide binders with a minimum film formation temperature (MFFT) as low as possible while still providing coatings' with desirable properties including, for example, durability and impact resistance. Durability is a key property in exterior applications to enable coatings to maintain color and gloss upon exposure to the elements such as sunlight.

Therefore, it is desirable to provide an aqueous polymer dispersion with low MFFT particularly suitable for use in aqueous coating compositions that provide coatings with the above properties.

### SUMMARY OF THE INVENTION

The present invention provides a novel aqueous dispersion of multistage polymer particles comprising at least three polymers. The aqueous dispersion of the present invention has good film formation property, for example, having a minimum film formation temperature (MFFT) lower than 10° C. An aqueous coating composition comprising the aqueous dispersion can provide coatings made therefrom with good durability, for example, as indicated by 600 gloss retention >0.5 after 1,100 hours of QUV testing, and balanced properties including, for example, impact resistance, early block resistance, print resistance, water resistance, and water whitening resistance. These properties may be measured according to the test methods described in the Examples section below.

In a first aspect, the present invention is an aqueous dispersion comprising a multistage polymer, wherein the first polymer having a Tg less than 0° C. comprises structural units of a carbonyl-containing functional monomer, and from zero to less than 0.1% by weight of the first polymer of structural units of a multifunctional monomer containing two or more different ethylenically unsaturated polymerizable groups;
wherein the second polymer having a Tg less than 0° C. comprises from 0.1% to 10% by weight of the second polymer of a multifunctional monomer containing two or more different ethylenically unsaturated polymerizable groups, and optionally structural units of a carbonyl-containing functional monomer; and
wherein the third polymer having a Tg higher than 50° C. comprises structural units of an ethylenically unsaturated nonionic monomer, and from zero to less than 0.1% by weight of the third polymer of structural units of a multifunctional monomer containing two or more different ethylenically unsaturated polymerizable groups; wherein the third polymer comprises, by weight based on the weight of the multistage polymer, from zero to less than 40% of structural units of methyl methacrylate.

In a second aspect, the present invention is a process of preparing the aqueous dispersion of the first aspect by multistage free-radical polymerization. The process comprises:
(i) preparing the first polymer in an aqueous medium by free-radical polymerization,
(ii) preparing the second polymer in the presence of the first polymer obtained from step (i) by free-radical polymerization, and
(iii) preparing the third polymer in the presence of the first polymer and the second polymer obtained from steps (i) and (ii) by free-radical polymerization.

In a third aspect, the present invention is an aqueous coating composition comprising the aqueous dispersion of the first aspect.

### BRIEF DESCRIPTION OF THE DRAWINGS

FIG. 1 is a scan transmission electron microscopy (STEM) image of multistage polymer particles in an aqueous dispersion of Comparative Example B.

FIG. 2 is a STEM image of multistage polymer particles in one embodiment of an aqueous dispersion of Example 1 described herein.

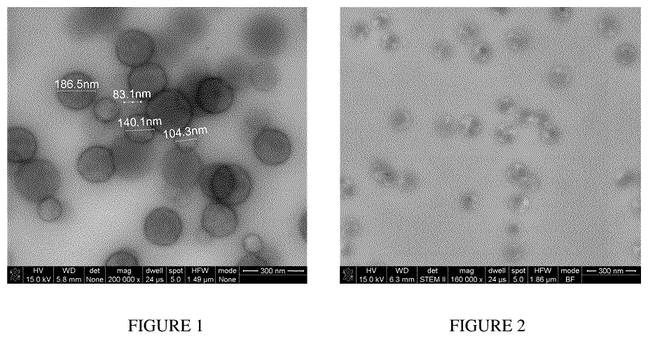

### DETAILED DESCRIPTION OF THE INVENTION

“Acrylic” in the present invention includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

As used herein, the term structural units, also known as polymerized units, of the named monomer refers to the remnant of the monomer after polymerization, or the monomer in polymerized form. For example, a structural unit of methyl methacrylate is as illustrated:

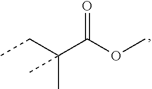

where the dotted lines represent the points of attachment of the structural unit to the polymer backbone.

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, and the like.

“Glass transition temperature” (T_{g}) in the present invention can be measured by various techniques including, for example, differential scanning calorimetry (DSC) or calculation by using a Fox equation (T. G. Fox, Bull. Am. Physics Soc., Volume 1, Issue No. 3, page 123 (1956)). For example, for calculating the T_{g} of a copolymer of monomers M₁ and M₂,

$$1 / {T}_{g} ( calc ) = \{ w ( {M}_{1} ) \div {T}_{g} ( {M}_{1} ) \} + \{ w ( {M}_{2} ) \div {T}_{g} ( {M}_{2} ) \}$$

wherein T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M_{I}) is the glass transition temperature of the homopolymer of monomer M_{I}, and T_{g}(M₂) is the glass transition temperature of the homopolymer of monomer M₂; all temperatures being in K. The glass transition temperatures of the homopolymers may be found, for example, in “Polymer Handbook”, edited by J. Brandrup and E. H. Immergut, Interscience Publishers.

“Multistage polymer” herein means a polymer prepared by the sequential addition of three or more different monomer compositions, comprising a first polymer, a second polymer, and a third polymer. By “first polymer” (also as “first stage polymer”), “second polymer” (also as “the second stage polymer”), and “third polymer” (also as “third stage polymer”) mean these polymers having different compositions and formed in different stages of multistage free-radical polymerization in preparing the multistage polymer. Each of the stages is sequentially polymerized and different from the immediately proceeding and/or immediately subsequent stage by a difference in monomer composition. “Weight of multistage polymer” in the present invention refers to the dry or solids weight of the multistage polymer.

The multistage polymer useful in the present invention is typically a multistage emulsion polymer. The multistage polymer may comprise structural units of one or more ethylenically unsaturated ionic monomers present in the first polymer, the second polymer, the third polymer, or combinations thereof, preferably in the first polymer. The term “ionic monomers” herein refers to monomers that bear an ionic charge between pH=1-14. The ethylenically unsaturated ionic monomers may include a, O-ethylenically unsaturated carboxylic acids and/or their anhydrides; a phosphorous-containing acid monomer, or salts thereof; 2-acrylamido-2-methylpropanesulfonic acid (AMPS), sodium salt of AMPS, ammonium salt of AMPS, sodium salt of 3-allyloxy-2-hydroxy-1-propanesulfonic acid, sodium styrene sulfonate (SSS), sodium vinyl sulfonate (SVS), sodium salt of allyl ether sulfonate; or mixtures thereof. Examples of suitable α,β-ethylenically unsaturated carboxylic acids include an acid-bearing monomer such as acrylic acid, methacrylic acid, maleic acid, itaconic acid, crotonic acid, or fumaric acid; or a monomer bearing an acid-forming group which yields or is subsequently convertible to, such an acid group (such as anhydride, (meth)acrylic anhydride, or maleic anhydride); or mixtures thereof. Examples of suitable phosphorous-containing acid monomers and salts thereof include phosphoalkyl (meth)acrylates such as phosphoethyl (meth)acrylate, phosphopropyl (meth)acrylate, phosphobutyl (meth)acrylate; salts thereof; and mixtures thereof; CH₂=C(R)—C(O)—O—(R¹O)_{q}—P(O)(OH)₂, wherein R=H or CH₃ and R¹=alkyl, and q=1-10, such as SIPOMER PAM-100, SIPOMER PAM-200, SIPOMER PAM-300 and SIPOMER PAM-600 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tripropylene glycol (meth)acrylate, salts thereof, or mixtures thereof. Preferred ethylenically unsaturated ionic monomer is itaconic acid. More preferably, the first polymer and/or the second polymer comprise structural units of itaconic acid. The first polymer, the second polymer, and/or the third polymer may each independently comprise structural units of the ethylenically unsaturated ionic monomer in an amount of from 0.5% to 10%, for example, 1% or more, 1.5% or more, 2% or more, 3% or more, or even 4% or more, and at the same times, 9% or less, 8% or less, 7% or less, 6% or less, or even 5% or less, by weight based on the weight of the first polymer, the second polymer, and the third polymer, respectively.

The multistage polymer useful in the present invention may comprise structural units of one or more carbonyl-containing functional monomers present in the first polymer, the second polymer, the third polymer, or combinations thereof. Preferably, the first polymer comprises structural units of the carbonyl-containing functional monomer. More preferably, both the first polymer and the second polymer comprise structural units of the carbonyl-containing functional monomer. Examples of suitable carbonyl-containing functional monomers include diacetone methacrylamide, diacetone acrylamide (DAAM), acetoacetoxy or acetoacetamide functional monomers including, for example, acetoacetoxyethyl (meth)acrylate such as acetoacetoxyethyl methacrylate (AAEM), acetoacetoxypropyl (meth)acrylate, acetoacetoxybutyl (meth)acrylate, 2,3-di(acetoacetamido)propyl (meth)acrylate, 2,3-di(acetoacetoxy) propyl (meth)acrylate, acetoacetamidoethyl (meth)acrylate, acetoacetamidopropyl (meth)acrylate, allyl acetoacetates, acetoactamidobutyl (meth)acrylate, vinyl acetoacetates; or mixtures thereof. Preferred carbonyl-containing functional monomer is diacetone acrylamide. The first polymer, the second polymer, and the third polymer may each independently comprise structural units of the carbonyl-containing functional monomer in an amount of from 0.5% to 10%, for example, 0.5% or more, 1% or more, 1.5% or more, 2% or more, 2.5% or more, 3% or more, 3.5% or more, or even 4% or more, and at the same time, 10% or less, 8% or less, 7% or less, 6% or less, or even 5% or less, by weight based on the weight of the first polymer, the second polymer, and the third polymer, respectively.

The multistage polymer useful in the present invention may also comprise structural units of one or more ethylenically unsaturated nonionic monomers, that are different from the monomers described above, present in the first polymer, the second polymer, the third polymer, or combinations thereof. As used herein, the term “nonionic monomers” refers to monomers that do not bear an ionic charge between pH=1-14. Suitable ethylenically unsaturated nonionic monomers may include, for example, alkyl esters of (meth)acrylic acids, vinyl aromatic monomers such as styrene and substituted styrene, vinyl esters of carboxylic acid, ethylenically unsaturated nitriles, or mixtures thereof. Examples of suitable ethylenically unsaturated nonionic monomers include C₁-C₂₀-, C₁-C₁₀-, or C₁-C₈-alkyl esters of (meth)acrylic acids including, for example, methyl acrylate, methyl methacrylate, ethyl acrylate, butyl acrylate, butyl methacrylate, 2-ethylhexyl acrylate, iso-butyl (meth)acrylate, hexyl (meth)acrylate, lauryl (meth)acrylate, stearyl (meth)acrylate, cyclohexyl (meth)acrylate, benzyl(meth)acrylate, oleyl(meth)acrylate, palmityl (meth)acrylate, nonyl(meth)acrylate, decyl (meth)acrylate, dodecyl (meth)acrylate, pentadecyl (meth) acrylate, hexadecyl (meth)acrylate, octadecyl (meth)acrylate, hydroxyethyl (meth)acrylate, or hydroxypropyl (meth)acrylate; (meth)acrylonitrile; (meth)acrylamide; alkylvinyldialkoxysilanes; vinyltrialkoxysilanes such as vinyltriethoxysilane and vinyltrimethoxysilane; (meth)acryl functional silanes including, for example, (meth)acryloxyalkyltrialkoxysilanes such as gamma-methacryloxypropyltrimethoxysilane and methacryloxypropyltriethoxysilane; 3-methacryloxypropylmethyldimethoxysilane; 3-methacryloxypropyltrimethoxysilane; 3-methacryloxypropyltriethoxysilane; or mixtures thereof. More preferably, the ethylenically unsaturated nonionic monomers are selected from the group consisting of styrene, substituted styrene, methyl methacrylate, methacrylate, ethyl acrylate, butyl methacrylate, butyl acrylate, iso-butyl acrylate, iso-butyl methacrylate, 2-ethylhexyl acrylate, lauryl methacrylate, lauryl acrylate, stearyl acrylate, stearyl methacrylate, hydroxyethyl acrylate, hydroxyethyl methacrylate, and mixtures thereof. The first polymer and the second polymer may each independently comprise, by weight based on the weight of the first and second polymer, respectively, from 75% to 99.9%, from 80% to 98%, from 85% to 96%, or from 90% to 95%, of structural units of the ethylenically unsaturated nonionic monomer. The third polymer may comprise, by weight based on the weight of the third polymer, from 90% to 100%, from 95% to 100%, from 96% to 99.5%, from 97% to 98.5%, of structural units of the ethylenically unsaturated nonionic monomer. Preferably, at least one of the first polymer and the second polymer comprises, by weight based on the weight of the multistage polymer, 4% or more of structural units of methyl methacrylate, for example, 4.1% or more, 4.2% or more, 4.3% or more, 4.4% or more, 4.5% or more, 4.6% or more, 4.7% or more, 4.8% or more, 4.9% or more, 5% or more, 5.1% or more, 5.2% or more, 5.3% or more, 5.4% or more, 5.5% or more, 5.6% or more, 5.7% or more, 5.8% or more, 5.9% or more, 6.0% or more, 6.1% or more, 6.2% or more, 6.3% or more, or even 6.4% or more. The third polymer may comprise, by weight based on the weight of the multistage polymer, from zero to less than 40% of structural units of methyl methacrylate, for example, 39% or less, 38% or less, 37% or less, 36% or less, 35% or less, 34% or less, 33% or less, 32% or less, 31% or less, or even 30% or less.

The multistage polymer, preferably the second polymer, useful in the present invention may comprise structural units of one or more multifunctional monomers containing two or more different ethylenically unsaturated polymerizable groups. The two or more different ethylenically unsaturated polymerizable groups usually have different reactivity. Each of the ethylenically unsaturated polymerizable groups may be selected from one of but different categories (i), (ii), (iii) and (iv): (i) an acryl group, (ii) a methacryl group, (iii) an allyl group (H₂C═CH—CH₂—), and (iv) other ethylenically unsaturated groups excluding (i), (ii), and (iii). The acryl group may be an acryloxy group or an acrylamino group. The methacryl group may be a methacryloxy group or a methacrylamino group. The other ethylenically unsaturated groups may include a vinyl group, a maleate group, a crotyl group, or a dicyclopentenyl group. Preferably, the multifunctional monomer contains at least one allyl group and at least one acryl or methacryl group. Suitable multifunctional monomers may include, for example, allyl (meth)acrylate, allyl (meth)acrylamide, allyl oxyethyl (meth)acrylate, crotyl (meth)acrylate, dicyclopentenyl (meth)acrylate, dicyclopentenyl ethyl (meth)acrylate, diallyl maleate, or mixtures thereof. The second polymer may comprise, by weight based on the weight of the second polymer, structural units of the multifunctional monomer in an amount of 0.1% or more, 0.3% or more, 0.5% or more, 0.6% or more, 0.7% or more, 0.8% or more, 0.9% or more, or even 1.0% or more, and at the same time, 10% or less, 9% or less, 8% or less, 7% or less, 6% or less, 5% or less, 4.5% or less, 4% or less, 3.5% or less, 3% or less, 2.5% or less, 2.2% or less, 2.0% or less, 1.8% or less, or even 1.5% or less. The first polymer and the third polymer may each independently comprise, by weight based on the weight of the first polymer and the third polymer, respectively, less than 0.1% of structural units of the multifunctional monomer, for example, less than 0.08%, less than 0.05%, less than 0.04%, less than 0.02%, less than 0.01%, or even zero. In some embodiments, the first polymer and the third polymer are substantially free, i.e., less than 0.01%, of structural units of the multifunctional monomer.

The first polymer in the multistage polymer may comprise, by weight based on the weight of the first polymer, structural units of the ethylenically unsaturated ionic monomer such as itaconic acid, structural units of the ethylenically unsaturated nonionic monomer, structural units of the carbonyl-containing functional monomer and less than 0.1% of structural units of the multifunctional monomer. Preferably, the first polymer comprises, by weight based on the weight of the first polymer, from 0.5% to 10% of structural units of the ethylenically unsaturated ionic monomer such as itaconic acid, from 0.5% to 10% of structural units of diacetone acrylamide, less than 0.1% of structural units of the multifunctional monomer, and structural units of the ethylenically unsaturated nonionic monomer. More preferably, the first polymer comprises 4% or more of structural units of methyl methacrylate, by weight based on the weight of the multistage polymer.

The second polymer in the multistage polymer may comprise, by weight based on the weight of the second polymer, structural units of the multifunctional monomer, structural units of the ethylenically unsaturated nonionic monomer, and optionally, structural units of the ethylenically unsaturated ionic monomer such as itaconic acid and structural units of the carbonyl-containing functional monomer. Preferably, the second polymer comprises, by weight based on the weight of the second polymer, from 0.1% to 5% of structural units of the multifunctional monomer, from zero to 5% of structural units of diacetone acrylamide, and structural units of the ethylenically unsaturated nonionic monomer. More preferably, the second polymer comprises 4% or more of structural units of methyl methacrylate, by weight based on the weight of the multistage polymer.

In some embodiments, the multistage polymer comprises, the first polymer with a Tg of 0° C. or less comprising, by weight based on the weight of the first polymer, from 1.0% to 10% of structural units of the ethylenically unsaturated ionic monomer including, for example, itaconic acid; from 1% to 6% of structural units of the carbonyl-containing functional monomer such as DAAM; from 84% to 97.5% of structural units of the ethylenically unsaturated nonionic monomer such as alkyl esters of (meth)acrylic acids; and less than 0.1% of structural units of the multifunctional monomer;
the second polymer with a Tg of 0° C. or less comprising, by weight based on the weight of the second polymer, from 90% to 99.5% of structural units of the ethylenically unsaturated nonionic monomer, from 0.5% to 2% of structural units of the multifunctional monomer including, for example, allyl methacrylate; from zero to 5% of structural units of the ethylenically unsaturated ionic monomer including, for example, itaconic acid; and from zero to 5% of structural units of the carbonyl-containing functional monomer such as DAAM; and
the third polymer with a Tg of 50° C. higher comprising, by weight based on the weight of the third polymer, structural units of the ethylenically unsaturated nonionic monomer and less than 0.1% of structural units of the multifunctional monomer.

The types and levels of the monomers described above may be chosen to provide the multistage polymer with a Tg suitable for different applications. The first polymer and the second polymer in the multistage polymer may have different or the same Tgs. The first polymer and the second polymer may each independently have a Tg less than 0° C., for example, −2° C. or less, −5° C. or less, −8° C. or less, −10° C. or less, −12° C. or less, −15° C. or less, or even −20° C. or less. The third polymer may have a Tg higher than 50° C., for example, 55° C. or more, 60° C. or more, 65° C. or more, 70° C. or more, 75° C. or more, or even 80° C. or more, as calculated by the Fox equation or measured by Differential Scanning Calorimetry (DSC) described in the Examples section below. Without being bounded by a theory, the multistage polymer may comprise multiple different phases or layers, which can be demonstrated by STEM or at least two Tgs as measured by DSC. When the first and second polymers have the same or similar Tgs, Tg peaks for these two polymers may overlap in the DSC testing. In some embodiments, the first polymer is the outer layer, the second polymer is the middle layer, and the third polymer is the inner layer, of the multistage polymer particles.

The first polymer may be present in the multistage polymer, by weight based on the weight of the multistage polymer, in an amount of from 10% to 50%, from 15% to 47%, or from 20% to 44%, from 25% to 40%, or from 30% to 35%. The second polymer may be present in the multistage polymer, by weight based on the weight of the multistage polymer, in an amount of from 10% to 60%, from 15% to 55%, or from 20% to 50%, from 25% to 45%, or from 30% to 40%. The third polymer in the multistage polymer may be present, by weight based on the weight of the multistage polymer, in an amount of from 10% to 55%, from 20% to 45%, or from 25% to 40%, or from 30% to 35%. Preferably, the multistage polymer comprises, by weight based on the weight of the multistage polymer, from 10% to 50% of the first polymer, from 10% to 60% of the second polymer, and from 10% to 55% of the third polymer. More preferably, the multistage emulsion polymer comprises from 15% to 45% of the first polymer, from 15% to 45% of the second polymer, and from 20% to 50% of the third polymer, by weight based on the weight of the multistage polymer.

The multistage polymer particles in the aqueous dispersion of the present invention may have an average particle size of from 50 nanometers (nm) to 500 nm, from 80 nm to 300 nm, or from 90 nm to 200 nm. The particle size herein refers to the number average particle size and may be measured by a Brookhaven BI-90 Plus Particle Size Analyzer.

In addition to the multistage polymer, the aqueous dispersion of the present invention may further comprise a polyfunctional carboxylic hydrazide containing at least two hydrazide groups per molecule. The polyfunctional carboxylic hydrazide may act as a crosslinker and may be selected from the group consisting of adipic dihydrazide, oxalic dihydrazide, isophthalic dihydrazide, polyacrylic polyhydrazides, and mixtures thereof. The polyfunctional carboxylic hydrazide may be present in an amount of from zero to 10%, from 0.05% to 7%, from 0.1% to 5%, from 0.2% to 2%, or from 0.5% to 1%, by weight based on the weight of the multistage polymer.

The aqueous dispersion of the present invention further comprises water. The concentration of water may be, by weight based on the total weight of the aqueous dispersion, from 30% to 90% or from 40% to 80%. Such aqueous dispersion is useful in many applications including, for example, wood coatings, metal coatings, architecture coatings, and traffic paints.

The process of preparing the aqueous dispersion comprising the multistage polymer may include multistage free-radical polymerization, preferably emulsion polymerization, in which at least three stages are formed sequentially, which usually results in the formation of the multistage polymer comprising at least three polymer compositions, optionally the different stages can be formed in different reactors. The process of preparing the aqueous dispersion may include (i) preparing a first polymer in an aqueous medium by free-radical polymerization, (ii) preparing a second polymer in the presence of the first polymer obtained from step (i) by free-radical polymerization, and (iii) preparing a third polymer in the presence of the first polymer and the second polymer obtained from steps (i) and (ii) by free-radical polymerization. The process may include a stage of polymerization of a first monomer composition (also as “stage 1 monomer composition”) to form the first polymer, a stage of polymerization of a second monomer composition (also as “stage 2 monomer composition”) to form the second polymer, and a stage of polymerization of a third monomer composition (also as “stage 3 monomer composition”) to form the third polymer. In some embodiments, the process of preparing the multistage polymer includes the first stage of polymerization to form the first polymer, subsequent the second stage of polymerization to form the second polymer in the presence of the first polymer, followed by the third stage of polymerization to form the third polymer. Each stage of the free-radical polymerization can be conducted by polymerization techniques well known in the art such as emulsion polymerization of the monomers described above. The first, second, and third monomer compositions may each independently include the monomers described above for forming the structural unis of the first, second, and third polymer, respectively. Total concentration of the monomer compositions for preparing the first polymer, the second polymer, and the third polymer, respectively, is equal to 100%. For each monomer, the concentration of the monomer based on the total weight of monomers used in preparing a polymer (e.g., the first polymer) is substantially the same as the concentration of structural units of such monomer based on the total weight of such polymer (e.g., the first polymer). The monomer compositions for preparing the first polymer, the second polymer, and the third polymer may be added neat or as an emulsion in water; or added in one or more additions or continuously, linearly or nonlinearly, over the reaction period of preparing the first polymer, the second polymer, and the third polymer, respectively, or combinations thereof. Temperature suitable for emulsion polymerization processes may be lower than 100° C., in the range of from 30 to 95° C., or in the range of from 50 to 90° C.

In the multistage free-radical polymerization process for preparing the multistage polymer, free radical initiators may be used in each stage. The polymerization process may be thermally initiated or redox initiated emulsion polymerization. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of 0.01 to 3.0% by weight, based on the total weight of monomers used for preparing the multistage polymer. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may optionally be used.

In the multistage free-radical polymerization process for preparing the multistage polymer, a surfactant may be used in one or more stages of the polymerization process. The surfactant may be added prior to or during the polymerization of the monomers, or combinations thereof. A portion of the surfactant can also be added after the polymerization. Surfactants may be used for at least one stage or all stages of preparing the multistage polymer. These surfactants may include anionic and/or nonionic emulsifiers. The surfactants can be reactive surfactants, e.g., polymerizable surfactants. Examples of suitable surfactants include alkali metal or ammonium salts of alkyl, aryl, or alkylaryl sulfates, sulfonates or phosphates; alkyl sulfonic acids; sulfosuccinate salts; fatty acids; and ethoxylated alcohols or phenols. Preferably, the alkali metal or ammonium salts of alkyl, aryl, or alkylaryl sulfates surfactant are used. The combined amount of the surfactant used is usually from zero to 10% or from 0.5% to 3%, by weight based on the weight of total monomers used for preparing the multistage polymer.

In the multistage free-radical polymerization process for preparing the multistage polymer, a chain transfer agent may be used in one or more stages of the polymerization process. Examples of suitable chain transfer agents include 3-mercaptopropionic acid, methyl mercaptopropionate, butyl mercaptopropionate, n-dodecyl mercaptan, benzenethiol, azelaic alkyl mercaptan, or mixtures thereof. The chain transfer agent may be used in an effective amount to control the molecular weight of the first polymer, the second polymer and/or the third polymer. The chain transfer agent may be used in an amount of from zero to 2%, from 0.1% to 1%, from 0.2% to 0.5%, or from 0.2% to 0.3%, by weight based on the total weight of monomers used for preparing the multistage polymer.

The obtained aqueous multistage polymer dispersion may be neutralized to a pH value of at least 6. Neutralization may be conducted by adding one or more bases which may lead to partial or complete neutralization of the ionic or latently ionic groups of the multistage polymer. Examples of suitable bases include ammonia; alkali metal or alkaline earth metal compounds such as sodium hydroxide, potassium hydroxide, calcium hydroxide, zinc oxide, magnesium oxide, sodium carbonate; primary, secondary, and tertiary amines, such as triethyl amine, ethylamine, propylamine, monoisopropylamine, monobutylamine, hexylamine, ethanolamine, diethyl amine, dimethyl amine, di-n-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, aluminum hydroxide; or mixtures thereof. The process of preparing the aqueous dispersion of the present invention may further comprise adding the polyfunctional carboxylic hydrazide containing at least two hydrazide groups per molecule described above to the aqueous dispersion.

The aqueous dispersion comprising the multistage polymer of the present invention demonstrates good film formation property, for example, having a minimum film formation temperature (MFFT) lower than 10° C. The MFFT is the lowest temperature at which the polymer particles of the aqueous dispersion will mutually coalesce and form a continuous film when the volatile component (e.g., water) evaporates. The MFFT can be determined according to the test method described in the Examples section below.

The aqueous dispersion comprising the multistage polymer is useful for use in coating applications without requiring the use of a coalescent. The present invention also relates to an aqueous coating composition comprising the aqueous dispersion comprising the multistage polymer in an amount of, for example, from 20% to 95%, from 30% to 85%, from 40% to 75%, or from 50% to 65%. “Coalescent” herein means a compound that is able to aid dispersed polymer particles to form a homogeneous coating film by reducing the film formation temperature of the polymer. The coalescent typically has a molecular weight less than 410. Examples of suitable coalescents include ethylene glycol monoethyl ether, ethylene glycol monopropyl ether, ethylene glycol monobutyl ether, ethylene glycol monohexyl ether, diethylene glycol monomethyl ether, diethylene glycol monoethyl ether, diethylene glycol monobutyl ether, diethylene glycol monohexyl ether, propylene glycol n-butyl ether, dipropylene glycol n-butyl ether, dipropylene glycol methyl ether, tripropylene glycol methyl ether, propylene glycol phenyl ether, propylene glycol tert-butyl ether, propylene glycol methyl ether acetate, dipropyleneglycol methyl ether acetate, propylene glycol diacetate, 2,2,4-thimethyl-1,3-pentanediol monoisobutyrate, 2,2,4-trimethyl-1,3-pentanediol diisobutyrate, or mixtures thereof. The amount of the coalescent in the aqueous coating composition may be from zero to less than 5%, less than 4.5%, less than 4%, less than 3.5%, less than 3%, less than 2.5%, less than 2%, less than 1.8%, less than 1.5%, less than 1.2%, less than 1%, less than 0.8%, less than 0.5%, or even less than 0.1%, by weight based on the weight of the multistage polymer.

Preferably, the aqueous coating composition is substantially free of the coalescent (i.e., less than 0.1%).

The aqueous coating composition of the present invention may also comprise one or more pigments. As used herein, the term “pigment” refers to a particulate inorganic material which is capable of materially contributing to the opacity or hiding capability of a coating. Such materials typically have a refractive index greater than 1.8. Examples of suitable pigments include titanium dioxide (TiO₂), zinc oxide, zinc sulfide, iron oxide, barium sulfate, barium carbonate, or mixtures thereof. The aqueous coating composition may also comprise one or more extenders. The term “extender” refers to a particulate inorganic material having a refractive index of less than or equal to 1.8 and greater than 1.3. Examples of suitable extenders include calcium carbonate, aluminium oxide (Al₂O₃), clay, calcium sulfate, aluminosilicate, silicate, zeolite, mica, diatomaceous earth, solid or hollow glass, ceramic bead, and opaque polymers such as ROPAQUE™ Ultra E available from The Dow Chemical Company (ROPAQUE is a trademark of The Dow Chemical Company), or mixtures thereof. The aqueous coating composition may have a pigment volume concentration (PVC) of from 5% to 50%, from 10% to 40%, from 15% to 30%, or from 20% to 25%.

The aqueous coating composition of the present invention may further comprise one or more defoamers. “Defoamers” herein refers to chemical additives that reduce and hinder the formation of foam. Defoamers may be silicone-based defoamers, mineral oil-based defoamers, ethylene oxide/propylene oxide-based defoamers, alkyl polyacrylates, or mixtures thereof. The defoamer may be present, by weight based on the total weight of the aqueous coating composition, generally from 0 to 3%, from 0.1% to 1%, or from 0.2% to 0.5%.

The aqueous coating composition of the present invention may further comprise one or more thickeners (also known as “rheology modifiers”). The thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose, or mixtures thereof. Preferred thickener is based on HEUR. The thickener may be present, by weight based on the total weight of the aqueous coating composition, from 0 to 10%, from 0.1% to 5%, from 0.2% to 1%, or from 0.3% to 0.7%.

The aqueous coating composition of the present invention may further comprise water. The concentration of water may be, by weight based on the total weight of the aqueous coating composition, from 20% to 90%, from 30% to 70%, or from 35% to 50%. In addition to the components described above, the aqueous coating composition may further comprise any one or combination of the following additives: buffers, neutralizers, dispersants, humectants, biocides, anti-skinning agents, colorants, flowing agents, anti-oxidants, plasticizers, freeze/thaw additives, leveling agents, thixotropic agents, adhesion promoters, anti-scratch additives, and grind vehicles. These additives may be present in a combined amount of, from 0 to 10%, from 0.1% to 6%, from 0.2% to 2%, or from 0.3% to 1%, by weight based on the total weight of the aqueous coating composition.

The aqueous coating composition of the present invention may provide coatings made therefrom with one or more of the following properties: good durability as indicated by 600 gloss retention >50% after the QUV testing for 1,100 hours or longer, for example, 51% or higher, 53% or higher, 55% or higher, 56% or higher, 57% or higher, or even 59% or higher; impact resistance with 40 cm-kg or more; early block resistance rated as B-1 or better; print resistance with a rating of 3 or higher; water resistance rated as 3 or higher; and water whitening resistance rated as 3 or lower. These properties are measured according to the test methods described in the Examples section below.

The aqueous coating composition of the present invention may be prepared with techniques known in the coating art. The process of preparing the aqueous coating composition may comprise admixing the aqueous dispersion comprising the multistage polymer, with other optional components as described above. Components in the aqueous coating composition may be mixed in any order to provide the aqueous coating composition of the present invention. Any of the above-mentioned optional components may also be added to the composition during or prior to the mixing to form the aqueous coating composition.

The aqueous coating composition of the present invention can be applied to a substrate by incumbent means including brushing, dipping, rolling and spraying. The aqueous coating composition is preferably applied by spraying. The standard spray techniques and equipment for spraying such as air-atomized spray, air spray, airless spray, high volume low pressure spray, and electrostatic spray such as electrostatic bell application, and either manual or automatic methods can be used. After the aqueous coating composition has been applied to a substrate, the aqueous coating composition may be dried, or be allowed to dry, at 5-25° C., or at an elevated temperature, for example, from 25 to 150° C. to form a film (this is, coating).

The aqueous coating composition of the present invention can be applied to, and adhered to, various substrates. Examples of suitable substrates include concrete, cementious substrates, wood, metals, stones, elastomeric substrates, glass or fabrics. The coating composition is suitable for various coating applications, such as architecture coatings, marine and protective coatings, automotive coatings, wood coatings, coil coatings, traffic paints, and civil engineering coatings. The aqueous coating composition can be used alone, or in combination with other coatings to form multi-layer coatings.

### Examples

Some embodiments of the invention will now be described in the following Examples, wherein all parts and percentages are by weight unless otherwise specified. The materials used in the examples and their abbreviations are given as below:

Itaconic Acid (IA), methacrylic acid (MAA), hydroxyethyl methacrylate (HEMA), methyl methacrylate (MMA), ethyl acrylate (EA), butyl acrylate (BA), styrene (ST), and allyl methacrylate (ALMA) are all available from The Dow Chemical Company.

Diacetone acrylamide (DAAM) and adipic dihydrazide (ADH) are both available from Koywa Chemical.

Tego Airex 902w polyether siloxane defoamer is available from Evonik.

BYK-346 polyether modified siloxane wetting agent is available from BYK.

ACRYSOL™ RM-8W hydrophobically modified ethoxylated urethane polymer thickener, Butyl CELLOSOLVE™ glycol ether (Ethylene glycol monobutyl ether), and DOWANOL™ DPnB glycol ether (Dipropylene glycol n-butyl Ether) are all available from The Dow Chemical Company (ACRYSOL, CELLOSOLVE and DOWANOL are trademarks of The Dow Chemical Company).

The following standard analytical equipment and methods are used in the Examples.

### MFFT

Minimum film formation temperature (MFFT) was measured in accordance with GB/T 9267-2008. MFFT less than 10° C. is desired.

Gloss Retention after QUV Testing

Gloss retention (%) is used as an indicator of coating films' durability. Gloss retention of coating films was determined by a QUV Accelerated Weathering Tester. A coating composition was applied onto Q panels (cold rolled steel) by a 150 μm applicator. The resultant film was then allowed to dry at 23° C. and relative humility (RH) of 50% for 7 days. Initial 60 degree gloss, denoted as “gloss_{(before QUV)}”, was measured by micro-TRI-gloss machine (BYK Company). The test panels were then placed into the QUV chamber (QUV/Spray Model, Q-Panel Company) with test area facing inward and exposed for desired length of time where one cycle consists of two procedures: exposure to ultraviolet (UV) light (wavelength: 340 nm) at 60° C. for 8 hours, and tuning off UV light and keeping the temperature at 40° C. for 4 hours.

Then the panels were removed from the QUV chamber, allowed to cool and dry, and tested for final 60 degree gloss, denoted as “gloss_{(after QUV)}”. Then gloss retention (%) of the coating films before and after the accelerated QUV testing is calculated by,

Gloss retention (%)=(gloss_{(after QUV)}/gloss_{(before QUV)})×100%

where gloss was measured in accordance with ASTM G154-06. Gloss retention >50% after 1,100 hours testing indicates good durability. The higher gloss retention, the better durability.

### Water Resistance

Water resistance of coating films was determined by BS EN 12720:2009. Panels were prepared by brush applying three coatings at 80-90 g/m² over wood (a black panel). After a first layer of coating, panels were left at room temperature (23±2° C.) for four hours, and then sanded with sand paper. A second layer of coating was then brushed onto the wood substrate and dried at room temperature for 4 hours. After applying a third layer of coating, panels were allowed to dry at room temperature for 4 hours, and then placed in an oven at 50° C. for 48 hours before conducting the water resistance testing.

Disc type filter paper were first saturated with water, placed on the above finished panels, and covered with a cap to reduce evaporation. After 24 hours, the cap was removed. Test area was wiped with wet facial tissues and allowed to dry at room temperature to observe the degree of damage. The test area was then rated for damage degree on a scale of 0-5, where 0 is the worst, and 5 is the best. The water resistance rating of 4 or higher is acceptable. The higher the rating, the better the water resistance.

1—Strong change: the structure of surface being distinctly changed, and/or discoloration, change in gloss and color, and/or the surface being totally or partially removed, and/or the filter paper adhering to the surface;

2—Significant change: test area clearly distinguishable from adjacent surrounding area, visible in all viewing directions, e.g., discoloration, change in gloss and color, and/or structure of surface slightly changed, e.g., swelling, fiber raising, cracking and blister;

3—Moderate change: test area distinguishable from adjacent surrounding area, visible in all viewing directions, e.g., discoloration, change in gloss and color, and no change in structure of surface, e.g., swelling, fiber raising, cracking and blister;

4—Slight change: test area distinguishable from adjacent surrounding area, only when the light source is mirrored on the test surface and is reflected towards the observer's eyes, e.g., discoloration, change in gloss and color, and no change in structure of surface, e.g., swelling, fiber raising, cracking and blister;

5—No change: test area indistinguishable from adjacent surrounding area.

### Water Whitening Resistance

The water whitening resistance (WWR) of an aqueous polymer dispersion sample was measured as follows. If the polymer has a MFFT of the aqueous polymer dispersion sample is not higher than 10° C., the polymer dispersion was used for WWR testing directly. If the aqueous polymer dispersion sample has a MFFT higher than 10° C., a certain amount of Texanol coalescent (available from Eastman) was added to adjust the MFFT of the resultant dispersion mixture to 10° C. and was kept at room temperature overnight prior to the water whitening resistance testing.

Then the above aqueous polymer dispersion sample (or the dispersion mixture) was applied on a glass plate with wet thickness of 100 μm and allowed to dry at room temperature for 24 hours to form a clear film. The coated plate was then dipped into deionized water for 24 hours. The water whitening of the clear film on the glass plate was monitored by visual observation and rated on a scale of 1-5, where 1 is the best, and 5 is the worst: 1=no whitening, 2=slight whitening, 3=moderate whitening, 4=strong whitening, 5=severe whitening. The rating being 3 or lower indicates good water whitening resistance.

Early Block Resistance Early block resistance was measured according to GB/T 23982-2009 standard. A wood block (7 cm×5 cm) was balanced at room temperature and 50% relative humidity (RH) for 7 days. One layer of coating was brushed onto the wood block at 80-90 grams per square meter (g/m²) of the wood, allowed to dry at room temperature for 3 hours, then sanded with sand paper. A second layer of coating was brushed onto the wood block at 80-90 g/m² and allowed to dry at room temperature for 24 hours. Two coated wood blocks were then stacked together face to face with 1 kg weight on them and placed into an oven at 50° C. for 4 hours. Then, the 1 kg weight was removed. The two stacked wood blocks were balanced at room temperature for 1 hour and then separated from each other to evaluate the early block resistance.

The rating of the early block resistance property is defined by the separating force and the area of damaging, where A: separated without any force; B: separated by a slight blow; C: separated by low force with hands; D: separated by medium force with hands; E: separated by huge force with hands; F: separated by tools; and the number indicating area of damage: 0: no damage; 1: ≤1%; 2: 1%-5%; 3: 5%-20%; 4: 20%-50%; 5: ≥50%.

A-0 represents the best and F-5 is the worst. Rating of B-1 or better is acceptable.

### Print Resistance

Coating films were drawn down on a glass substrate with a 120 μm wired bar, and then allowed to dry for 16 hours at room temperature. Two coated glass panels obtained above were stacked together face to face with cloth in between. Then 2 psi (13789 Pascal) pressure was applied to the stacked panels and held for 24 hours at room temperature. The two stacked panels were then separated from each other to evaluate the print resistance property. The print resistance is rated by trace left on the coating films on a scale of 1-5, where 1 is the worst and 5 is the best: 5=no trace; 4=minor trace; 3=significant trace; 2=coating film damage; 1=cannot separate. Rating of 3 or higher is acceptable.

### Impact Resistance

Impact resistance was measured in accordance with ASTM D5420-10 using a BYK GARDNER Impact Tester for coatings on cold rolled steels. The results are reported in cm-kg (centimeter-kilogram). Impact resistance of 40 cm-kg or higher is acceptable.

### DSC

DSC was used to measure Tgs. A 5-10 milligram (mg) sample was analyzed in a sealed aluminum pan on a TA Instrument DSC Q2000 fitted with an auto-sampler under a nitrogen (N₂) atmosphere. Tg measurement was conducted with three cycles including, from −80 to 200° C. at a rate of 10° C./min followed by holding for 5 minutes (1^{st} cycle), from 200 to −80° C. at a rate of 10° C./min (2^{nd} cycle), and from −80 to 200° C. at a rate of 10° C./min (3^{rd} cycle). Tg was obtained from the 3^{rd} cycle by taking the mid-point in the heat flow versus temperature transition as the Tg value.

### Example (Ex) 1

A stage 1 monomer emulsion (ME1) was prepared by mixing deionized (DI) water (140 g), sodium lauryl sulphate (SLS) surfactant (28%, 5 g), MMA (140 g), IA (13.5 g) in DI water (65 g), DAAM (9 g) in DI water (50 g), and BA (431 g) together to produce a stable monomer emulsion.

A stage 2 monomer emulsion (ME2) was prepared by mixing DI water (140 g), SLS surfactant (28%, 5 g), MMA (131 g), ALMA (9 g), IA (13.5 g) in DI water (65 g), DAAM (9 g) in DI water (50 g), and BA (431 g) together to produce a stable monomer emulsion.

A stage 3 monomer emulsion (ME3) was prepared by mixing DI water (121 g), SLS surfactant (28%, 4 g), and MMA (511 g) together to produce a stable monomer emulsion.

To a 5-liter, four-necked round bottom flask equipped with a paddle stirrer, a thermocouple, nitrogen inlet, and reflux condenser was added DI water (560 g), and stirring was initiated. The contents of the flask were heated to 90° C. under a N₂ atmosphere. SLS surfactant (28%, 18 g), sodium carbonate (2.6 g) in DI water (30 g), and ammonium persulfate (APS) (6 g) in DI water (32 g) were added to the flask, followed by a rinse with DI water (100 g). ME1 was then added over 21 minutes (mins). After completion of the ME1 feed, DI water (11 g) was added as a rinse. ME2 was then added over 21 mins. After completion of the ME2 feed, DI water (11 g) was added as a rinse. ME3 was then added over 17 mins. After completion of the ME3 feed, DI water (10 g) was added as a rinse. The contents of the flask were maintained at 87-89° C. during the additions. At the end of polymerization, a mixture of FeSO₄·7H₂O (0.010 g) in DI water (5 g) and a salt of ethylenediaminetetraacetic acid (EDTA) (0.018 g) in DI water (5 g), a solution of t-butyl hydroperoxide (t-BHP) (70% active) (1.2 g t-BHP dissolved in 22 g DI water), and a solution of isoascorbic acid (IAA) (0.7 g IAA dissolved in 20 g DI water) were all added to the flask at 60° C., then ammonia (25%, 7.0 g) in DI water (14 g) and ADH (7 g) in DI water (85 g) were added to the flask at 50° C., to obtain the aqueous dispersion.

### Ex 2

The aqueous dispersion of Ex 2 was prepared as in Ex 1 except monomer emulsions used for three stages were prepared as follows,

A stage 1 monomer emulsion (ME1) was prepared by mixing deionized (DI) water (140 g), SLS surfactant (28%, 5 g), MMA (140 g), IA (13.5 g) in DI water (65 g), DAAM (9 g) in DI water (50 g), and BA (431 g) together to produce a stable monomer emulsion.

A stage 2 monomer emulsion (ME2) was prepared by mixing DI water (140 g), SLS surfactant (28%, 5 g), MMA (135.5 g), ALMA (4.5 g), IA (13.5 g) in DI water (65 g), DAAM (9 g) in DI water (50 g), and BA (431 g) together to produce a stable monomer emulsion.

A stage 3 monomer emulsion (ME3) was prepared by mixing DI water (121 g), SLS surfactant (28%, 4 g), and MMA (511 g) together to produce a stable monomer emulsion.

### Ex 3

A stage 1 monomer emulsion (ME1) was prepared by mixing deionized (DI) water (120 g), SLS surfactant (28%, 4.3 g), MMA (115 g), IA (13.5 g) in DI water (65 g), DAAM (9 g) in DI water (50 g), and BA (371 g) together to produce a stable monomer emulsion.

A stage 2 monomer emulsion (ME2) was prepared by mixing DI water (120 g), SLS surfactant (28%, 4.3 g), MMA (107 g), ALMA (8 g), IA (13.5 g) in DI water (65 g), DAAM (9 g) in DI water (50 g), and BA (371 g) together to produce a stable monomer emulsion.

A stage 3 monomer emulsion (ME3) was prepared by mixing DI water (161 g), SLS surfactant (28%, 5.8 g), and ST (682 g) together to produce a stable monomer emulsion.

To a 5-liter, four-necked round bottom flask equipped with a paddle stirrer, a thermocouple, nitrogen inlet, and reflux condenser was added DI water (560 g), and stirring was initiated. The contents of the flask were heated to 90° C. under a N₂ atmosphere. SLS surfactant (28%, 18 g), sodium carbonate (2.6 g) in DI water (30 g), and APS (6 g) in DI water (32 g) were added to the flask, followed by a rinse with DI water (100 g). ME1 was then added over 18 minutes. After completion of the ME1 feed, DI water (11 g) was added as a rinse. ME2 was then added over 18 mins. After completion of the ME2 feed, DI water (11 g) was added as a rinse. ME3 was then added over 24 mins. After completion of the ME3 feed, DI water (10 g) was added as a rinse. The contents of the flask were maintained at 87-89° C. during the additions. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added to the flask at 60° C., then ammonia (25%, 7.0 g) in DI water (14 g) and ADH (7 g) in DI water (85 g) were added to the flask at 50° C., to obtain the aqueous dispersion.

### Ex 4

A stage 1 monomer emulsion (ME1) was prepared by mixing deionized (DI) water (120 g), SLS surfactant (28%, 3.1 g), MMA (41 g), EA (78 g), HEMA (6 g), IA (18.5 g), DAAM (12.5 g), and BA (157 g) together to produce a stable monomer emulsion. A stage 2 monomer emulsion (ME2) was prepared by mixing DI water (72 g), SLS surfactant (28%, 4.3 g), MMA (47 g), ALMA (3 g), EA (78 g) and BA (156 g) together to produce a stable monomer emulsion. A stage 3 monomer emulsion (ME3) was prepared by mixing DI water (143 g), SLS surfactant (28%, 6.1 g), MMA (299) and ST (299 g) together to produce a stable monomer emulsion.

To a 5-liter, four-necked round bottom flask equipped with a paddle stirrer, a thermocouple, nitrogen inlet, and reflux condenser was added DI water (560 g), and stirring was initiated. The contents of the flask were heated to 90° C. under a N₂ atmosphere. SLS surfactant (28% active, 18 g), sodium carbonate (2.6 g) in DI water (30 g), and APS (6 g) in DI water (32 g) were added to the flask, followed by a rinse with DI water (100 g). ME1 was then added over 15 mins. After completion of the ME1 feed, DI water (11 g) was added as a rinse. ME2 was then added over 15 mins. After completion of the ME2 feed, DI water (11 g) was added as a rinse. ME3 was then added over 30 mins. After completion of the ME3 feed, DI water (10 g) was added as a rinse. The contents of the flask were maintained at 87-89° C. during the additions. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added to the flask at 60° C., then ammonia (25%, 7.0 g) in DI water (14 g) and ADH (4.9 g) in DI water (85 g) were added to the flask at 50° C., to obtain the aqueous dispersion.

### Ex 5

A stage 1 monomer emulsion (ME11) was prepared by mixing deionized (DI) water (180 g), SLS surfactant (28%, 6.6 g), MMA (171 g), IA (20.3 g) in DI water (127 g), DAAM (13.4 g) in DI water (112 g), and BA (557 g) together to produce a stable monomer emulsion.

A stage 2 monomer emulsion (ME2) was prepared by mixing DI water (60 g), SLS surfactant (28%, 2.2 g), MMA (58 g), ALMA (7.6 g), IA (6.8 g) in DI water (42 g), DAAM (4.5 g) in DI water (37 g), and BA (186 g) together to produce a stable monomer emulsion.

A stage 3 monomer emulsion (ME3) was prepared by mixing DI water (162 g), SLS surfactant (28%, 5.8 g), ST (682 g) together to produce a stable monomer emulsion.

To a 5-liter, four-necked round bottom flask equipped with a paddle stirrer, a thermocouple, nitrogen inlet, and reflux condenser was added DI water (560 g), and stirring was initiated. The contents of the flask were heated to 90° C. under a N₂ atmosphere. SLS surfactant (28%, 18 g), sodium carbonate (2.6 g) in DI water (30 g), and APS (6 g) in DI water (32 g) were added to the flask, followed by a rinse with DI water (100 g). ME1 was then added over 27 mins. After completion of the ME1 feed, DI water (11 g) was added as a rinse. ME2 was then added over 9 mins. After completion of the ME2 feed, DI water (11 g) was added as a rinse. ME3 was then added over 24 mins. After completion of the ME3 feed, DI water (10 g) was added as a rinse. The contents of the flask were maintained at 87-89° C. during the additions. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added to the flask at 60° C., then ammonia (25%, 7.0 g) in DI water (14 g) and ADH (7 g) in DI water (85 g) were added to the flask at 50° C., to obtain the aqueous dispersion.

### Ex 6

A stage 1 monomer emulsion (ME1) was prepared by mixing DI water (60 g), SLS surfactant (28%, 2.2 g), MMA (65.6 g), IA (6.8 g) in DI water (42 g), DAAM (4.5 g) in DI water (37 g), and BA (186 g) together to produce a stable monomer emulsion.

A stage 2 monomer emulsion (ME2) was prepared by mixing deionized (DI) water (180 g), SLS surfactant (28%, 6.6 g), MMA (163.4 g), ALMA (7.6 g), IA (20.3 g) in DI water (127 g), DAAM (13.4 g) in DI water (112 g), and BA (557 g) together to produce a stable monomer emulsion.

A stage 3 monomer emulsion (ME3) was prepared by mixing DI water (162 g), SLS surfactant (28%, 5.8 g), ST (682 g) together to produce a stable monomer emulsion.

To a 5-liter, four-necked round bottom flask equipped with a paddle stirrer, a thermocouple, nitrogen inlet, and reflux condenser was added DI water (560 g), and stirring was initiated. The contents of the flask were heated to 90° C. under a N₂ atmosphere. SLS surfactant (28%, 18 g), sodium carbonate (2.6 g) in DI water (30 g), and APS (6 g) in DI water (32 g) were added to the flask, followed by a rinse with DI water (100 g). ME1 was then added over 9 mins. After completion of the ME1 feed, DI water (11 g) was added as a rinse. ME2 was then added over 27 mins. After completion of the ME2 feed, DI water (11 g) was added as a rinse. ME3 was then added over 24 mins. After completion of the ME3 feed, DI water (10 g) was added as a rinse. The contents of the flask were maintained at 87-89° C. during the additions. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added to the flask at 60° C., then ammonia (25%, 7.0 g) in DI water (14 g) and ADH (7 g) in DI water (85 g) were added to the flask at 50° C., to obtain the aqueous dispersion.

### Comparative (Comp) Ex A

A stage 1 monomer emulsion (ME1) was prepared by mixing DI water (140 g), SLS surfactant (28%, 5 g), MMA (140 g), IA (13.5 g) in DI water (65 g), DAAM (9 g) in DI water (50 g), and BA (431 g) together to produce a stable monomer emulsion. A stage 2 monomer emulsion (ME2) was prepared by mixing DI water (140 g), SLS surfactant (28%, 5 g), MMA (140 g), IA (13.5 g) in DI water (65 g), DAAM (9 g) in DI water (50 g), and BA (431 g) together to produce a stable monomer emulsion. A stage 3 monomer emulsion (ME3) was prepared by mixing DI water (121 g), SLS surfactant (28%, 4 g), and MMA (511 g) together to produce a stable monomer emulsion.

To DI water (560 g) under a N₂ atmosphere at 90° C., was added SLS surfactant (28%, 18 g), sodium carbonate (2.6 g) in DI water (30 g), and APS (6 g) in DI water (32 g) followed by a DI water rinse (100 g) to form a reaction mixture. ME1 was then added at 88° C. over 21 mins. After completion of the ME1 feed, DI water (11 g) was added as a rinse. ME2 was then added at 88° C. over 21 mins. After completion of the ME2 feed, DI water (11 g) was added as a rinse.

ME3 was then added at 88° C. over 17 mins. After completion of the ME3 feed, DI water (10 g) was added as a rinse. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added at 60° C., then ammonia (25%, 7.0 g) in DI water (14 g) and ADH (7 g) in DI water (85 g) were added at 50° C., to obtain the aqueous dispersion.

### Comp Ex B

A stage 1 monomer emulsion (ME1) was prepared by mixing DI water (120 g), SLS surfactant (28%, 4.3 g), MMA (115 g), IA (13.5 g) in DI water (65 g), DAAM (9 g) in DI water (50 g), and BA (371 g) together to produce a stable monomer emulsion. A stage 2 monomer emulsion (ME2) was prepared by mixing DI water (120 g), SLS surfactant (28%, 4.3 g), MMA (107 g), ALMA (8 g), IA (13.5 g) in DI water (65 g), DAAM (9 g) in DI water (50 g), and BA (371 g) together to produce a stable monomer emulsion. A stage 3 monomer emulsion (ME3) was prepared by mixing DI water (161 g), SLS surfactant (28%, 5.8 g), and MMA (682 g) together to produce a stable monomer emulsion.

To DI water (560 g) under a N₂ atmosphere at 90° C., was added SLS surfactant (28%, 18 g), sodium carbonate (2.6 g) in DI water (30 g), and APS (6 g) in DI water (32 g) followed by a DI water rinse (100 g) to form a reaction mixture. ME1 was then added at 88° C. over 18 mins. After completion of the ME1 feed, DI water (11 g) was added as a rinse. ME2 was then added at 88° C. over 18 mins. After completion of the ME2 feed, DI water (11 g) was added as a rinse. ME3 was then added at 88° C. over 24 mins. After completion of the ME3 feed, DI water (10 g) was added as a rinse. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added at 60° C., then ammonia (25%, 7.0 g) in DI water (14 g) and ADH (7 g) in DI water (85 g) were added at 50° C., to obtain the aqueous dispersion.

### Comp Ex C

A stage 1 monomer emulsion (ME1) was prepared by mixing deionized (DI) water (120 g), SLS surfactant (28%, 3.1 g), MMA (44.8 g), EA (78 g), ALMA (3 g), HEMA (6 g), IA (18.5 g), DAAM (12.5 g), and BA (157 g) together to produce a stable monomer emulsion. A stage 2 monomer emulsion (ME2) was prepared by mixing DI water (72 g), SLS surfactant (28%, 4.3 g), MMA (47 g), ALMA (3 g), EA (78 g) and BA (156 g) together to produce a stable monomer emulsion. A stage 3 monomer emulsion (ME3) was prepared by mixing DI water (143 g), SLS surfactant (28%, 6.1 g), MMA (299) and ST (299 g) together to produce a stable monomer emulsion.

To a 5-liter, four-necked round bottom flask equipped with a paddle stirrer, a thermocouple, nitrogen inlet, and reflux condenser was added DI water (560 g), and stirring was initiated. The contents of the flask were heated to 90° C. under a N₂ atmosphere. SLS surfactant (28%, 18 g), sodium carbonate (2.6 g) in DI water (30 g), and APS (6 g) in DI water (32 g) were added to the flask, followed by a rinse with DI water (100 g). ME1 was then added over 15 mins. After completion of the ME1 feed, DI water (11 g) was added as a rinse. ME2 was then added over 15 mins. After completion of the ME2 feed, DI water (11 g) was added as a rinse. ME3 was then added over 30 mins. After completion of the ME3 feed, DI water (10 g) was added as a rinse. The contents of the flask were maintained at 87-89° C. during the additions. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added to the flask at 60° C., then ammonia (25%, 7.0 g) in DI water (14 g) and ADH (4.9 g) in DI water (85 g) were added to the flask at 50° C., to obtain the aqueous dispersion.

### Comp Ex D

A stage 1 monomer emulsion (ME1) was prepared by mixing DI water (283 g), SLS surfactant (28%, 10 g), MMA (281 g), BA (863 g), MAA (36 g) and DAAM (18 g) together to produce a stable monomer emulsion. A stage 2 monomer emulsion (ME2) was prepared by mixing DI water (121 g), SLS surfactant (28%, 4 g), MMA (511 g) together to produce a stable monomer emulsion.

To DI water (560 g) under a N₂ atmosphere at 90° C., was added SLS surfactant (28%) (18 g), sodium carbonate (2.6 g) in DI water (3 g), a portion of ME1 (19 g) and APS (6 g) in DI water (32 g) followed by DI water (100 g) to form a reaction mixture. The remainder of ME1 was then added at 88° C. over 42 mins. After completion of the ME1 feed, DI water (22 g) was added as a rinse. ME2 was then added at 88° C. over 17 mins. After completion of the ME2 feed, DI water (10 g) was added as a rinse. At the end of polymerization, FeSO₄·7H₂O (0.010 g) in DI water (5 g) mixed with a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added at 60° C., then ammonia (25%, 7.0 g) in DI water (14 g) and ADH (7 g) in DI water (85 g) were added at 50° C., to obtain the aqueous dispersion.

### Comp Ex E

The aqueous dispersion of Comp Ex E was prepared as Comp Ex B except monomer emulsions were prepared as follows,

A stage 1 monomer emulsion (ME1) was prepared by mixing DI water (120 g), SLS surfactant (28%, 4.3 g), MMA (221 g), IA (13.5 g) in DI water (65 g), DAAM (9 g) in DI water (50 g), and BA (265 g) together to produce a stable monomer emulsion. A stage 2 monomer emulsion (ME2) was prepared by mixing DI water (120 g), SLS surfactant (28%, 4.3 g), MMA (213 g), ALMA (8 g), IA (13.5 g) in DI water (65 g), DAAM (9 g) in DI water (50 g), and BA (265 g) together to produce a stable monomer emulsion. A stage 3 monomer emulsion (ME3) was prepared by mixing DI water (161 g), SLS surfactant (28%, 5.8 g), and ST (682 g) together to produce a stable monomer emulsion.

### Comp Ex F

The aqueous dispersion of Comp Ex F was prepared as in Comp Ex B except monomer emulsions were prepared as follows,

A stage 1 monomer emulsion (ME1) was prepared by mixing DI water (120 g), SLS surfactant (28%, 4.3 g), MMA (115 g), IA (13.5 g) in DI water (65 g), DAAM (9 g) in DI water (50 g), and BA (371 g) together to produce a stable monomer emulsion. A stage 2 monomer emulsion (ME2) was prepared by mixing DI water (120 g), SLS surfactant (28%, 4.3 g), MMA (115 g), IA (13.5 g) in DI water (65 g), DAAM (9 g) in DI water (50 g), and BA (371 g) together to produce a stable monomer emulsion. A stage 3 monomer emulsion (ME3) was prepared by mixing DI water (161 g), SLS surfactant (28%, 5.8 g), ALMA (8 g), and MMA (674 g) together to produce a stable monomer emulsion.

### Comp Ex G

A stage 1 monomer emulsion (ME1) was prepared by mixing DI water (240 g), SLS surfactant (28%, 8.6 g), MMA (222 g), BA (742 g), IA (27 g) in DI water (130 g), ALMA (8 g), DAAM (18 g) in DI water (100 g), together to produce a stable monomer emulsion. A stage 2 monomer emulsion (ME2) was prepared by mixing DI water (161 g), SLS surfactant (28%, 5.8 g), ST (682 g) together to produce a stable monomer emulsion.

To DI water (560 g) under a N₂ atmosphere at 90° C., was added SLS surfactant (28%) (18 g), sodium carbonate (2.6 g) in DI water (3 g), a portion of ME1 (19 g) and APS (6 g) in DI water (32 g) followed by DI water (100 g) to form a reaction mixture. The remainder of ME1 was then added at 88° C. over 36 mins. After completion of the ME1 feed, DI water (22 g) was added as a rinse. ME2 was then added at 88° C. over 24 mins. After completion of the ME2 feed, DI water (10 g) was added as a rinse. At the end of polymerization, FeSO₄·7H₂O (0.010 g) in DI water (5 g) mixed with a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added at 60° C., then ammonia (25%, 7.0 g) in DI water (14 g) and ADH (7 g) in DI water (85 g) were added at 50° C., to obtain the aqueous dispersion.

### Comp Ex H

The aqueous dispersion of Comp Ex H was prepared as in Comp Ex B except monomer emulsions used were prepared as follows,

A stage 1 monomer emulsion (ME1) was prepared by mixing DI water (120 g), SLS surfactant (28%, 4.3 g), MMA (115 g), IA (13.5 g) in DI water (65 g), DAAM (9 g) in DI water (50 g), and BA (371 g) together to produce a stable monomer emulsion. A stage 2 monomer emulsion (ME2) was prepared by mixing DI water (120 g), SLS surfactant (28%, 4.3 g), MMA (107 g), IA (13.5 g) in DI water (65 g), ALMA (8 g), DAAM (9 g) in DI water (50 g), and BA (371 g) together to produce a stable monomer emulsion. A stage 3 monomer emulsion (ME3) was prepared by mixing DI water (161 g), SLS surfactant (28%, 5.8 g), ALMA (8 g), and MMA (674 g) together to produce a stable monomer emulsion.

### Comp Ex I

A stage 1 monomer emulsion (ME1) was prepared by mixing DI water (170 g), SLS surfactant (28%, 4.3 g), MMA (121 g), IA (13.5 g) in DI water (65 g), and BA (374 g) together to produce a stable monomer emulsion. A stage 2 monomer emulsion (ME2) was prepared by mixing DI water (170 g), SLS surfactant (28%, 4.3 g), MMA (121 g), ALMA (8 g), IA (13.5 g) in DI water (65 g), and BA (374 g) together to produce a stable monomer emulsion. A stage 3 monomer emulsion (ME3) was prepared by mixing DI water (161 g), SLS surfactant (28%, 5.8 g), and ST (682 g) together to produce a stable monomer emulsion.

To DI water (560 g) under a N₂ atmosphere at 90° C., was added SLS surfactant (28%, 18 g), sodium carbonate (2.6 g) in DI water (30 g), and APS (6 g) in DI water (32 g) followed by a DI water rinse (100 g) to form a reaction mixture. ME1 was then added at 88° C. over 18 mins. After completion of the ME1 feed, DI water (11 g) was added as a rinse. ME2 was then added at 88° C. over 18 mins. After completion of the ME2 feed, DI water (11 g) was added as a rinse. ME3 was then added at 88° C. over 24 mins. After completion of the ME3 feed, DI water (10 g) was added as a rinse. At the end of polymerization, a mixture of FeSO₄·7H₂O (0.010 g) in DI water (5 g) and a salt of EDTA (0.018 g) in DI water (5 g), a solution of t-BHP (70% active) (1.2 g t-BHP dissolved in 22 g DI water), and a solution of IAA (0.7 g IAA dissolved in 20 g DI water) were all added at 60° C., then ammonia (25%, 7.0 g) in DI water (14 g) and DI water (85 g) were added at 50° C., to obtain the aqueous dispersion.

Table 1 gives compositions and properties of the polymer dispersions obtained above. As shown in Table 1, all inventive polymer dispersions showed MFFT lower than 10° C. without requiring the use of any coalescent. In contrast, the polymer dispersions of Comp Exs B-C and E-H all showed undesirably high MFFT. Large amounts of coalescents are required for these polymer dispersions of Comp Exs B-C and E-H to form films at 10° C., which make them difficult to produce low VOC coating compositions. Without being bound by theory, it's believed that the second polymer containing structural units of ALMA in the multistage polymer of the present invention helps improve the compatibility between the first polymer phase and the third polymer phase.

TABLE 1
Compositions and properties of polymer dispersions

| Polymer | Calculated | Measured | MFFT, | | Viscosity³, | Particle | Solid, % |
|---|---|---|---|---|---|---|---|
| Dispersion | Tgs¹, ° C. | Tgs², ° C. | ° C. | pH | cps | size⁴, nm | by weight |
| Comp Ex A | −24/−24/105 | NA | <10 | 7.45 | 42 | 209 | 48.11 |
| Comp Ex B | −24/−25/105 | NA | 25 | 8.03 | 56 | 199 | 47.85 |
| Comp Ex C | −18/−28/103 | NA | 33 | 8.52 | 205 | 99 | 48.58 |
| Comp Ex D | −23/105 | NA | <10 | 7.76 | 416 | 110 | 48.91 |
| Comp Ex E | 4/4/100 | 11/103 | 28 | 7.84 | 66 | 205 | 47.26 |
| Comp Ex F | −24/−24/100 | −17/94 | 18 | 7.65 | 76 | 146 | 47.45 |
| Comp Ex G | −24/100 | −14/94 | 21 | 7.89 | 47 | 150 | 47.25 |
| Comp Ex H | −24/−25/100 | −12/88 | 15 | 7.81 | 53 | 179 | 47.24 |
| Comp Ex I | −24/−25/100 | −14/98 | <10 | 7.38 | 41 | 151 | 47.74 |
| Ex 1 | −23/−24/105 | −14/96 | <10 | 7.81 | 26 | 205 | 47.15 |
| Ex 2 | −23/−24/105 | −14/82 | <10 | 7.29 | 177 | 119 | 47.07 |
| Ex 3 | −24/−25/100 | −11/93 | <10 | 7.45 | 72 | 215 | 48.00 |
| Ex 4 | −17/−27/103 | −18/96 | <10 | 7.17 | 157 | 120 | 48.56 |
| Ex 5 | −24/−25/100 | −14/91 | <10 | 7.91 | 62 | 206 | 47.56 |
| Ex 6 | −24/−25/100 | −15/93 | <10 | 7.97 | 52 | 200 | 47.67 |

¹Calculated Tgs refer to Tgs calculated by the Fox equation;
²For measured Tgs of all examples except Comp Ex G, peaks for the first polymer and the second polymer overlapped with each other as detected by DSC;
³Viscosity was measured by Brookfield viscometer DV-I Primer (60 revolutions per minute, rpm);
⁴Particle size herein refers to the number average particle size as determined by Brookhaven BI-90 Plus Particle Size Analyzer.

### Coating Compositions

The aqueous polymer dispersions obtained above were used as binders for preparing coating compositions, based on binder types (aqueous polymer dispersions) shown in Table 2.

For preparing coating compositions except Comp Coating B, ingredients including binder (726 g), water (84.9 g), Tego Airex 902w (3 g), BYK-346 (3.1 g), water (130 g), and ACRYSOL RM-8W (3 g) were added sequentially and mixed using a conventional lab mixer (800 rpm) to form the coating compositions of Coatings 1-6, Comp Coatings A, B, D and I (solids content: 35.9%). For preparing the coating composition of Comp Coating B, ingredients including the binder of Comp Ex B (726 g), water (84.9 g), Butyl CELLOSOLVE (18 g), DOWANOL DPnB (9 g), Tego Airex 902w (3 g), BYK-346 (3.1 g), water (103 g), and ACRYSOL RM-8W (3 g) were added sequentially and mixed using a conventional lab mixer (800 rpm) to form the coating composition (solids content: 35.9%).

The obtained coating compositions were evaluated according to the test methods described above and results of properties are shown in Table 2. As shown in Table 2, coating compositions comprising the inventive binders all provided coating films with satisfactory gloss retention and balanced mechanical properties of water resistance, WWR, early block resistance, print resistance and impact resistance. The coating composition of Comp Coating A provided coating films with unsatisfactory gloss retention, water resistance and print resistance properties, as no ALMA was used in the second stage of polymerization of the binder of Comp Ex A. The coating composition comprising the binder of Comp Ex B showed unsatisfactory impact resistance. The binder of Comp Ex D, a two-stage emulsion polymer containing no structural units of ALMA, provided coating films with unsatisfactory gloss retention and poor early block resistance and print resistance properties (Comp Coating D). The coating composition comprising the binder of Comp Ex I free of structural units of DAAM demonstrated unacceptable early block resistance and print resistance properties (Comp Coating I).

TABLE 2
Properties of Coatings

| | | 60° gloss retention | | | | | | Early | | Impact |
|---|---|---|---|---|---|---|---|---|---|---|
| | Binder | QUV time (hours) | | | | Water | | block | Print | resistance |
| Coating | Type | 0 | 502 | 838 | 1262 | resistance | WWR | resistance | resistance | (cm-kg) |
| Comp | Comp | 1 | 49% | 41% | 32% | 2-3 | 2 | B-1 | 2 | 50 |
| Coating A | Ex A | | | | | | | | | |
| Comp | Comp | 1 | 106% | 105% | 104% | NA | NA | A-0 | 4 | 30 |
| Coating B | Ex B | | | | | | | | | |
| Comp | Comp | 1 | 31% | 25% | 24% | NA | NA | C-1 | 2 | 50 |
| Coating D | Ex D | | | | | | | | | |
| Comp | Comp | NA | NA | NA | NA | 5 | 2 | D-0 | 2 | 50 |
| Coating I | Ex I | | | | | | | | | |
| Coating 1 | Ex 1 | 1 | 96% | 93% | 94% | 5 | 2 | B-0 | 3 | 40 |
| Coating 2 | Ex 2 | 1 | 72% | 65% | 59% | 5 | 2 | B-1 | 3 | 50 |
| Coating 3 | Ex 3 | 1 | NA | 93% | 92% | 5 | 1 | B-0 | 3 | 50 |
| Coating 4 | Ex 4 | 1 | NA | 101% | 97% | 5 | 1 | B-1 | 3-4 | 50 |
| Coating 5 | Ex 5 | 1 | NA | 70% | 63% | 5 | 2 | B-0 | 3 | 50 |
| Coating 6 | Ex 6 | 1 | NA | 97% | 95% | 5 | 1 | A-0 | 3-4 | 50 |

What is claimed is:

1. A coating composition comprising an aqueous dispersion of a multistage polymer, wherein the multistage polymer comprises a first polymer, a second polymer, and a third polymer,
wherein the first polymer has a Tg less than 0° C. and comprises structural units of a carbonyl-containing functional monomer;
wherein the second polymer has a Tg less than 0° C. and comprises from 0.1% to 10% by weight of the second polymer of a multifunctional monomer containing two or more different ethylenically unsaturated polymerizable groups; and
wherein the third polymer having a Tg higher than 50° C. comprises structural units of an ethylenically unsaturated nonionic monomer,
wherein a coating formed from the coating composition has a 600 gloss retention >50% after the QUV testing for 1,100 hours or longer and/or impact resistance of at least 40 cm-kg.

2. The coating composition of claim 1 wherein the first polymer comprises from 0 to 0.1% by weight of the first polymer of structural units of a multifunctional monomer containing two or more different ethylenically unsaturated polymerizable groups.

3. The coating composition of claim 1 wherein the third polymer comprises from zero to less than 0.1% by weight of the third polymer of structural units of a multifunctional monomer containing two or more different ethylenically unsaturated polymerizable groups; wherein the third polymer comprises, by weight based on the weight of the multistage polymer, from zero to less than 40% of structural units of methyl methacrylate.

4. The coating composition of claim 1, wherein the first polymer and the second polymer each independently comprise, by weight based on the weight of the first polymer and the second polymer, respectively, from 0.5% to 10% of structural units of the carbonyl-containing functional monomer.

5. The coating composition of claim 1, further comprising a polyfunctional carboxylic hydrazide containing at least two hydrazide groups per molecule.

6. The coating composition of claim 3, wherein the polyfunctional carboxylic hydrazide is selected from the group consisting of adipic dihydrazide, oxalic dihydrazide, isophthalic dihydrazide, polyacrylic polyhydrazides, and mixtures thereof.

7. The coating composition of claim 1, wherein the carbonyl-containing functional monomer is diacetone acrylamide.

8. The coating composition of claim 1, wherein the multistage polymer comprises, by weight based on the weight of the multistage polymer, from 10% to 50% of the first polymer, from 10% to 60% of the second polymer, and from 10% to 55% of the third polymer.

9. The coating composition of claim 1, wherein the first polymer further comprises structural units of an ethylenically unsaturated ionic monomer and structural units of an ethylenically unsaturated nonionic monomer.

10. The coating composition of claim 1, wherein the second polymer further comprises structural units of an ethylenically unsaturated nonionic monomer, and optionally, structural units of an ethylenically unsaturated ionic monomer.

11. The coating composition of claim 9, wherein the ethylenically unsaturated ionic monomer is selected from the group consisting of acrylic acid, methacrylic acid, maleic acid, itaconic acid, crotonic acid, fumaric acid, and mixtures thereof.

12. The coating composition of claim 9, wherein at least one of the first polymer and the second polymer comprises 4% or more of structural units of methyl methacrylate, by weight based on the weight of the multistage polymer.

13. The coating composition of claim 1, wherein the ethylenically unsaturated nonionic monomer is selected from the group consisting of styrene or substituted styrene, methacrylate, methyl methacrylate, ethyl acrylate, butyl methacrylate, butyl acrylate, iso-butyl acrylate, iso-butyl methacrylate, 2-ethylhexyl acrylate, lauryl methacrylate, lauryl acrylate, stearyl acrylate, stearyl methacrylate, hydroxyethyl acrylate, hydroxyethyl methacrylate, and mixtures thereof.

14. The coating composition of claim 1, wherein the multifunctional monomer is selected from the group consisting of allyl (meth)acrylate, allyl (meth)acrylamide, allyl oxyethyl (meth)acrylate, crotyl (meth)acrylate, dicyclopentenyl (meth)acrylate, dicyclopentenyl ethyl(meth)acrylate, diallyl maleate, and mixtures thereof.

15. The coating composition of claim 1 comprising from 0 to less than 5% of a coalescent.

16. The coating composition of claim 1 further comprising one or more pigments, one or more extenders, one or more defoamers, one or more thickeners, or one or more additives selected from buffers, neutralizers, dispersants, humectants, biocides, anti-skinning agents, colorants, flowing agents, anti-oxidants, plasticizers, freeze/thaw additives, leveling agents, thixotropic agents, adhesion promoters, anti-scratch additives, and grind vehicles.

17. A coating made from the composition of claim 1 having a 600 gloss retention >50% after the QUV testing for 1,100 hours or longer and an impact resistance of at least 40 cm-kg.

18. The coating of claim 17 having one or more of
early block resistance rated as B-1 or better;
print resistance with a rating of 3 or higher; water resistance rated as 3 or higher;
water whitening resistance rated as 3 or lower.

19. A process of preparing the aqueous dispersion comprising a multistage polymer of by multistage free-radical polymerization, comprising:
(i) preparing a first polymer in an aqueous medium by free-radical polymerization,
(ii) preparing a second polymer in the presence of the first polymer obtained from step (i) by free-radical polymerization, and
(iii) preparing a third polymer in the presence of the first polymer and the second polymer obtained from steps (i) and (ii) by free-radical polymerization,
wherein the multistage polymer comprises the first polymer, the second polymer, and the third polymer,
wherein the first polymer has a Tg less than 0° C., and comprises structural units of a carbonyl-containing functional monomer, and from zero to less than 0.1% by weight of the first polymer of structural units of a multifunctional monomer containing two or more different ethylenically unsaturated polymerizable groups;
wherein the second polymer has a Tg less than 0° C. and comprises from 0.1% to 10% by weight of the second polymer of a multifunctional monomer containing two or more different ethylenically unsaturated polymerizable groups, and optionally structural units of a carbonyl-containing functional monomer; and
wherein the third polymer has a Tg higher than 50° C. and comprises structural units of an ethylenically unsaturated nonionic monomer, and from zero to less than 0.1% by weight of the third polymer of structural units of a multifunctional monomer containing two or more different ethylenically unsaturated polymerizable groups; wherein the third polymer comprises, by weight based on the weight of the multistage polymer, from zero to less than 40% of structural units of methyl methacrylate.

20. The process of preparing the aqueous dispersion of claim 18, further comprising adding a polyfunctional carboxylic hydrazide containing at least two hydrazide groups per molecule to the aqueous dispersion.
